(19) United States
(12) Patent Application Publication
(10) Pub. No.: US 2019/0094263 A1
(43) Pub. Date: Mar. 28, 2019

(54) Bluetooth Enabled Tool Movement Recording System

(71) Applicant: James Chun, Vista, CA (US)

(72) Inventor: James Chun, Vista, CA (US)

(21) Appl. No.: 16/140,358

(22) Filed: Sep. 24, 2018

Related U.S. Application Data
(60) Provisional application No. 62/562,234, filed on Sep. 22, 2017.

(51) Int. Cl. G01P 15/14; H04W 4/02; H04W 4/80; G06F 1/16

(52) U.S. Cl. CPC G01P 15/14; H04W 4/026; G06F 2200/1637; H04W 4/027; G06F 1/1613; H04W 4/80

(57) ABSTRACT

The invention disclosed herein is a tool movement recording system that includes a tool movement module either built into an existing hand tool or assembled inside an attachable ancillary housing. The tool includes a primary measurement sensor that measures or senses' the tool's primary function or purpose. The primary measurement sensor is coupled to a microcontroller and may be connected to one or more secondary sensors, said as an accelerometer or gyroscope. The microcontroller is connected to a first Bluetooth transceiver configured to pair with a second Bluetooth transceiver located in a nearby Smart phone. The Smart phone includes a microcontroller with working memory and a software application configured to present the information received by the second Bluetooth transceiver and display the information on the Smart phone's display or into a save file.

This non-provisional patent application is based on and claims the filing date benefit of U.S. provisional patent application (Application No. 62/562,234) filed on Sep. 22, 2017.

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

### 1. Field of the Invention

This invention pertains to adapters for tools that provide readout data to the user, and more particularly to tools that transmit readout data to a Smartphone and reviewed immediately or later.

### 2. Description of the Related Art

Watches and smartphones can precisely measure the distance, the speed and the acceleration of an end user. These devices include GPS transceivers and accelerometers and software programs that convert the analog signals into digital signals that can be saved or transformed into visual information that can be presented to the device's display.

Hand tools, such laser linear devices, have primary sensors that measure the distance from the user to a particular surface or object. Electronic levels have primary sensors that measure whether the level is positioning horizontally or vertically or positioning at an angle between the horizontal or vertical axes. Digital compasses have primary sensors that measure the orientation of a device with reference to the North pole.

When using some hand tools, such as power drills, power saws, and wrenches, do not have primary sensors but require the user to move the hand tool a particular distance along one axis and at a particular rate. For example, on a power hand drill, the primary movement of the tool is the rotation of the drill bit and primary sensor is not needed. Secondary movements which include the orientation of the hand drill to the working surface and the rate the drill is forced into the working surface may be needed. When using a power drill to blindly drill a hole in a wall that contains electrical wires or a plumbing, it important monitor these secondary movements such as the orientation and distance drill bit travels into wall to prevent damage to the wires or plumbing located inside the wall. Later, if an electrical short occurs in the electrical circuit or if a leak occurs in the plumbing conduit, there's currently no way to determine if use of the power drill may have damage the wiring or plumbing.

Another example of a hand tool, that does not need a primary sensor but may find a secondary sensor desirable, is a plumber's wrench. When tightening a threaded plumbing fixture on a threaded pipe, it is important to apply a sufficient amount of torque to the plumbing fixture to prevent leaks. Sensors that monitor the amount of torque exerted on the handle would be considered secondary sensors.

Today, most workers carry their Smart phones with built-in displays and Bluetooth transceivers on the construction jobsite.

What is needed is a tool movement recording system for a hand tool in which second movement is important for proper use of the hand tool that allows the end user to monitor both the tool's primary movement and the secondary movement.

### SUMMARY OF THE INVENTION

The invention disclosed herein is a hand tool movement recording system that includes a tool movement module either built into an existing hand tool or assembled inside an ancillary housing that selectively attaches to the hand tool.

A term ‘tool’ is used as a subset of hand tools that are manually held and operated by a user that requires the user to move the tool in a particular manner or at a particular rate or requires the tool to be maintained at a stationary location or at a partially orientation while a working implement attached to the tool is operated.

The term ‘Smartphone’ refers to a mobile telephone that performs the functions of telephone such as placing and receive telephone calls, but functions as a computer typically having a touchscreen interface, Internet access, and an operating system and sufficient working memory capable of running downloaded software applications.

The tool includes a tool movement module that includes at least one sensor that measures either the primary movement of the tool, and a secondary movement of the tool, such as the orientation, acceleration, or direction of movement of the tool during use. Which movement is the primary movement and which movement is the secondary movement will vary depending on the nature of the tool. The tool movement module includes microcontroller with a software program configured to collect and if necessary transform analogy signal into digital signals. When the tool's a transmission mode is activated, the first Bluetooth transceiver inside the tool or inside the ancillary housing transmits the movement data from these sensors to a secondary Bluetooth transceiver in the user's Smart phone.

The first Bluetooth transceiver is configured to pair with a second Bluetooth transceiver located in a nearby Smart phone. The Smart phone includes a display and working memory; and a software application configured to present the digital information from the module adapter to the Smart phone's display. When the Smart phone is operated in the vicinity of the module and the software application is activated on the Smart phone, tool movement information is automatically transmitted from the Smart phone's Bluetooth transceiver and displayed on the Smart phone's display. An optional ‘SAVE’ feature is provided that allows the user to save the data from the first Bluetooth transceiver.

### DESCRIPTION OF THE DRAWINGS

FIG. 1 is a simple diagram showing a tool with a primary sensor and a built in tool measurement module or with an ancillary housing with a tool measurement module assembled therein attached to the tool.

FIG. 2 is a diagram showing the measurement sensor connected to a first Bluethooth transceiver that sends data to a second Bluetooth transceiver in a Smart phone.

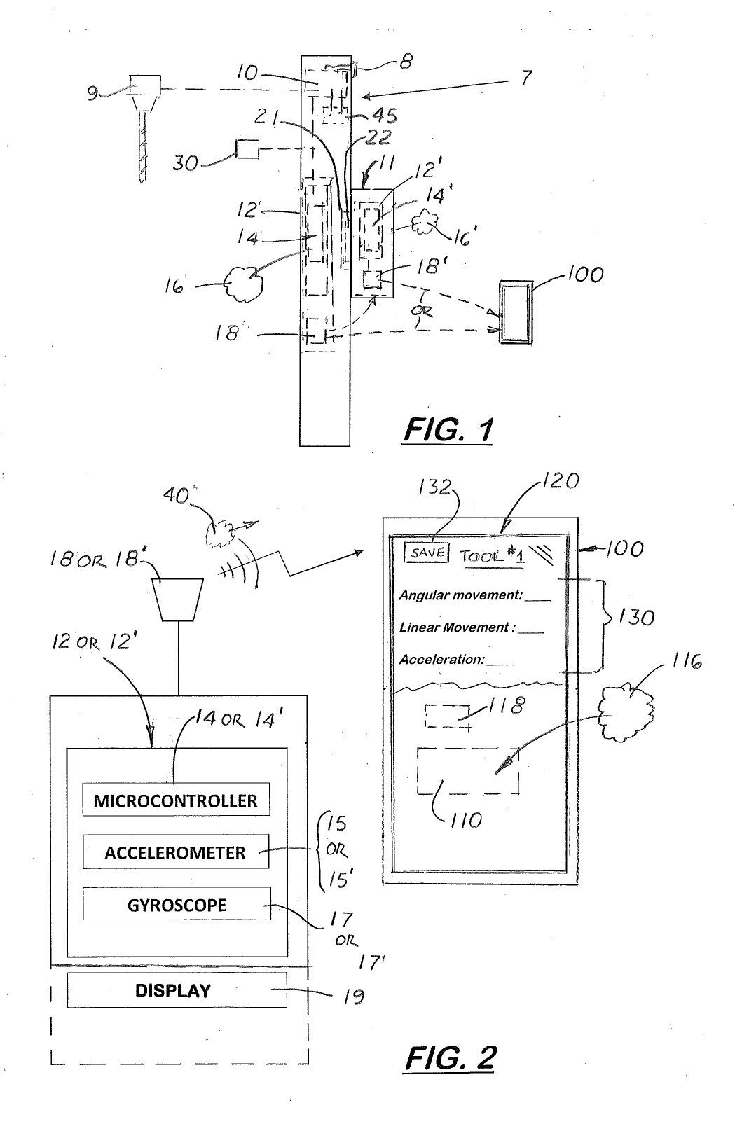

### DESCRIPTION OF THE PREFERRED EMBODIMENT(S)

The invention disclosed herein is a tool movement recording system for a hand tool 7, A term ‘hand tool’ is used as a subset of hand tools operated by a user that requires the user to move the tool in a particular manner or at a particular rate, or requires the tool 7 to be maintained at a stationary location or at a partially orientation while a working implement 9 attached to the tool 7 is operated. The tool 7 includes an ON-OFF switch 8 and a primary sensor 10 that monitors the tool's primary movement 7

The tool movement recording system includes a tool movement module 12, 12′ coupled to the primary sensor 10. In one embodiment, the tool movement module 12 is located inside the tool 7. In a second embodiment, the movement module 12′ is located in an ancillary housing 11 that includes a connection port 22 that connects to a compatible port 21 on the tool 7.

In both embodiments, the tool movement module 12, 12′ includes microcontroller 14, 14′ with a software program 16, 16′, respectively, loaded into its working memory. Coupled to the microcontroller 14, 14′ is a first Bluetooth transceiver 18, 18′, respectively. The software program 16, 1′ is configured to collect data information from the primary sensor 10 and, if necessary, transform analogy signals into digital signals that may be used by the microcontroller 14, 14′ and forward to the first Bluetooth transceiver 18, 18′. When the tool's switch 8 is moved to the ON position, transmission is activated, and the first Bluetooth transceiver 18, 18′ transmits a wireless signal 40 to a secondary Bluetooth transceiver 118 in the user's Smart phone 100.

In addition to the microcontroller 14, 14′, the tool movement module 12, 12′ may also include secondary sensors, such as an accelerometer 15, 15′ and a gyroscope 17, 17′.

The module 12, 12′ may also include a display 19 that allows the information from the sensor 10, the accelerometer 15, 15′ and gyroscope 17, 17′ to be displayed. The depending on the type of sensor 10 used, the module 12, 12′ may also include an analog/digital converter 30 attached to the sensor 10 and the accelerometer 15, 15′ and gyroscope 17, 17′ that converts an analog signals into a digital signal. It should be understood that in some tools, a primary sensor 10 is not present used so that only information from the accelerometer 15, 15′ and/or gyroscope 17, 17′ are displayed

As stated above, mounted inside the tool 8 on inside the ancillary housing 11 is a first Bluetooth transceiver 18, 18′, respectively. The first Bluetooth transceiver 18, 18′ is configured to pair with a second Bluetooth transceiver 118 located in a nearby Smart phone 100.

The Smart phone 100 includes a microcontroller 110 coupled to the second Bluetooth transceiver 118. Loaded into the microcontroller's working memory a software application 116 configured to present the digital information from the first Bluetooth transceiver 18, 18′. The Smart phone includes a display 120 on which Angular Movement, Linear Movement and Acceleration information, generally indicated by the number 130, are presented. The type of information displayed may vary depending on the nature of the tool and the primary and secondary sensors. The software program 116 is also configured to present a SAVE button 132 on the display enabling the user to data the information from the tool 7 for later review.

When the Smart phone is operated in the vicinity of the adapter and the software application 116 is activated on the Smart phone 100, readings from the sensors 10, 15, 15′, and 17, 17′ are automatically transmitted from the first Bluetooth transceivers 18, 18′ and displayed on the Smart phone's display 120.

More specifically, the tool 8 includes an internal battery 45 that energizes the sensors 10, 15, 15′ 17 and 17′ and the First Bluetooth transceivers 18, 18.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A Tool movement recording system for a hand tool that is moved or held or has a working implement that is moved or held at a particular orientation by an end user, the system comprising:
a. a tool movement module, the module includes at least one measurement sensor that measures the orientation, acceleration of the tool or the working implement;
b. a microcontroller configured to receive information from said sensor,
c. a first Bluetooth transceiver coupled to said microcontroller;
d. a Smart phone with a second Bluetooth transceiver configured to pair with said first Bluetooth transceiver, said Smartphone also includes a microcontroller, with working memory and a visual display; and
e. a Smartphone application program configured to be loaded into the working memory of the Smartphone; the software application configured to present the information from the first Bluetooth transceiver on the visual display.

2. The tool movement recording system, as recited in claim 1, where said tool includes a connection port and the movement module is located inside an ancillary housing that selectively attaches to the connection port.

3. The tool movement recording system, as recited in claim 1, wherein said Smartphone application program is configured to allow data delivered to the Smartphone to be saved.
